(19) United States
(12) Patent Application Publication
(10) Pub. No.: US 2011/0249884 A1
(43) Pub. Date: Oct. 13, 2011

(54) CHECKING APPARATUS AND METHOD FOR CHECKING HOLES POSITION AND SIZE IN A PLATE

(75) Inventor: PEI-CHONG TANG, Tu-Cheng (TW)

(73) Assignee: HON HAI PRECISION INDUSTRY CO., LTD., Tu-Cheng (TW)

(21) Appl. No.: 13/081,520

(22) Filed: Apr. 7, 2011

(30) Foreign Application Priority Data
Apr. 9, 2010 (CN) 201010143532.2

(51) Int. Cl. G06K 9/00

(52) U.S. Cl. 382/141

(57) ABSTRACT

A checking apparatus for checking holes position and size in a plate. The checking apparatus includes a memory, an image obtaining unit and a processor. The memory stores a file. The file records an expected number, size and placement of pixels representing the holes and a pixel value. The image obtaining unit obtains an image of the plate. The processor determines a target region in the image according to the values recorded in the file, scans the target region to obtain the number and placement of pixels representing the hole in the target region with a value equal to a pixel value. In addition, the processor compares the obtained number and placement of pixels representing the hole with the expected number and placement of pixels, and generates a signal to indicate the holes defined in the target region are defective if the obtained number and placement of pixels do not match the expected number and placement of pixels. A method for checking holes position and size in a plate is also disclosed.

### BACKGROUND

1. Technical Field

The present disclosure relates to checking apparatuses, and particularly to a checking apparatus for checking holes position and size in a plate.

2. Description of Related Art

Steel plates with holes are often used in surface mount technology (SMT), and solder paste is applied on the surface of printed circuit boards (PCBs) via the holes. Before using the steel plate the holes need to be checked to ensure proper placement, and size. However, the checking is usually done manually, and when there are a lot of holes the procedure takes too much time and is subject to human error.

Therefore, there is room for improvement in the art.

### BRIEF DESCRIPTION OF THE DRAWINGS

The components of the drawings are not necessarily drawn to scale, the emphasis instead being placed upon clearly illustrating the principles of the embodiments of the checking apparatus. Moreover, in the drawings, like reference numerals designate corresponding parts throughout several views.

FIG. 1 is a block diagram of a checking apparatus for checking holes position and size in a plate in accordance with an embodiment; the checking apparatus includes a processor.

FIG. 2 is a drawing view of an image of a target region of the plate to be checked in accordance with an embodiment.

FIG. 3 is a block diagram of the processor of FIG. 1 in accordance with an embodiment.

FIG. 4 is a flowchart of a method applied in the checking apparatus of FIG. 1 for checking holes position and size in a plate in accordance with the embodiment.

### DETAILED DESCRIPTION

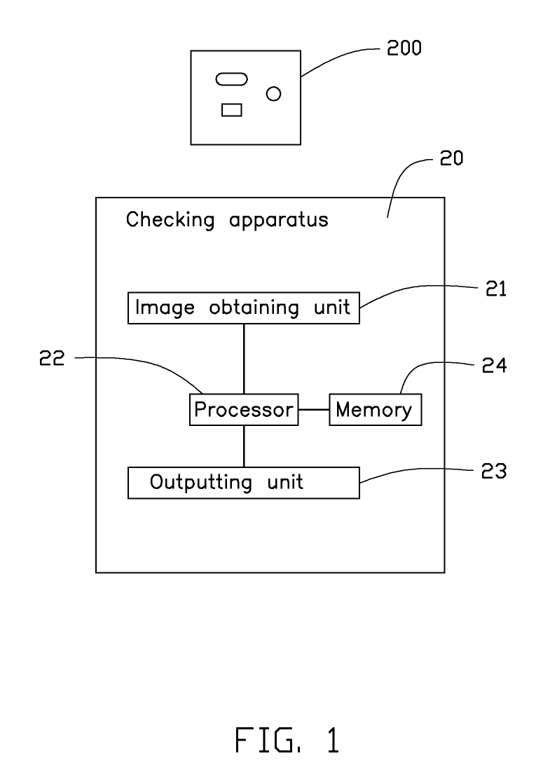

Referring to FIG. 1, a checking apparatus 20 for checking holes position and size in a plate 200, is provided. In some embodiments, the plate 200 may be a steel plate used in Surface mounted technology (SMT) The checking apparatus 20 includes an image obtaining unit 21, a processor 22, an outputting unit 23 and a memory 24. The memory 24 is used for storing a predetermined file for recording the size of the steel plate, number of holes defined in the steel plate, the positions of the holes defined in the steel plate and the expected number, size and placement of pixels in an image determined to represent holes in plate 200. In the embodiment, positions of the holes are indicated using an X, Y coordinate system.

The image obtaining unit 21 is used for obtaining an image of the steel plate. The processor 22 is used for determining a target region in the obtained image, according to the position of holes recorded in the predetermined file, and processing the obtained target image to generate image data. In addition, the processor 22 further obtains the number and placement of pixels determined to represent the hole in the target region with a value equal to a predetermined pixel value. The processor 22 compares the obtained number and placement of pixels that represent the hole with the expected number and placement of pixels and generates a comparison. If the comparison is not a match, the processor 22 generates a signal indicating the hole is defective. The predetermined pixel value is also stored in the memory 24, and is used for reflecting the color of holes defined in the steel plate. In the embodiment, the obtained target image is converted to the grayscale digital image with the processor 22. The binary numbers 0 and 1 respectively represent black pixels and white pixels of the obtained image. Because the holes defined in the steel plate are displayed in white in the obtained image, the predetermined pixel value is 1. Therefore, the processor 22 obtains the number and placement of the pixels by scanning the pixels whose pixel value is 1 (white pixel).

The outputting unit 23 is used to output information according to the signal generated by the processor 22. In the embodiment, the outputting unit 23 is a display, the outputting unit 23 displays images.

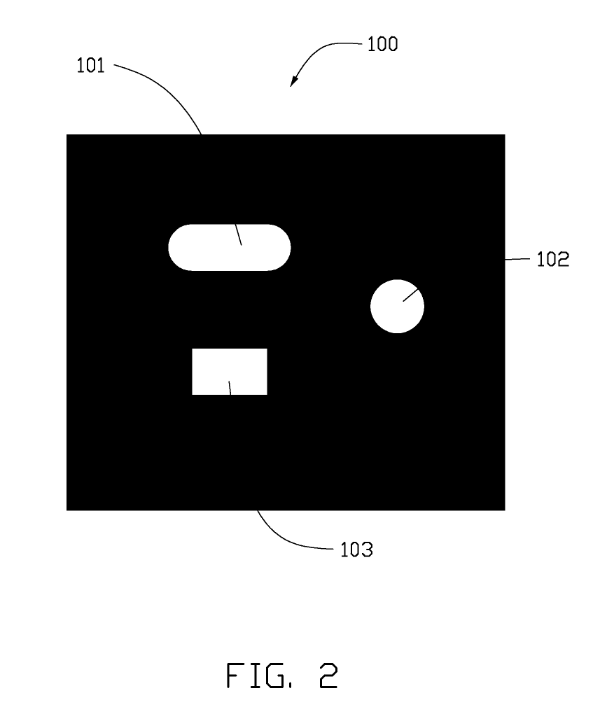

Referring further to FIG. 2, for better understanding of the working process of the checking apparatus 20, an image 100 of a steel plate is taken as an example. The image obtaining unit 21 obtains the image 100. The image 100 includes three white regions 101, 102 and 103. Each white region corresponds to a hole defined in the steel plate. The processor 22 obtains a target region in the image 100 (such as the white region 101) according to the position of the holes recorded in the predetermined file, and scans the target region to obtain the number and placement of white pixels in the white region 101. The processor 22 compares the obtained number and placement of white pixels with the expected number and placement of white pixels recorded in the predetermined file and generate a comparison. If the comparison is not a match, the processor 22 generates a signal indicating the hole is defective. The outputting unit 23 displays notice message to inform the user.

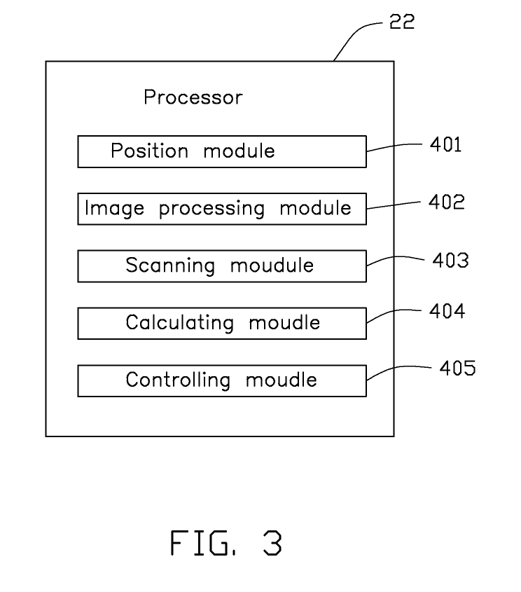

Referring to FIG. 3, the processor 22 includes a position obtaining module 401, an image processing module 402, a scanning module 403, a comparing module 404, and a controlling module 405. The position module 401 is used to determine a target region in the obtained image according to the position of holes recorded in the predetermined file. The image processing module 402 is used to process the target region to generate image data. In the embodiment, the image processing module 402 processes the target region with the calculated gray level to generate serial image data described in pixel. The scanning module 403 is used to scan the target region processed by the image processing module 402 with gray level to obtain the number and placement of pixels determined to represent the hole in the target region with a value equal to a predetermined pixel value. The comparing module 404 compares the obtained number and placement of pixels that represent the hole with the expected number and placement of pixels, and generates a comparison if the comparison is not a match. The controlling module 405 generates a signal indicating that holes defined in the target region are defective according to the comparison.

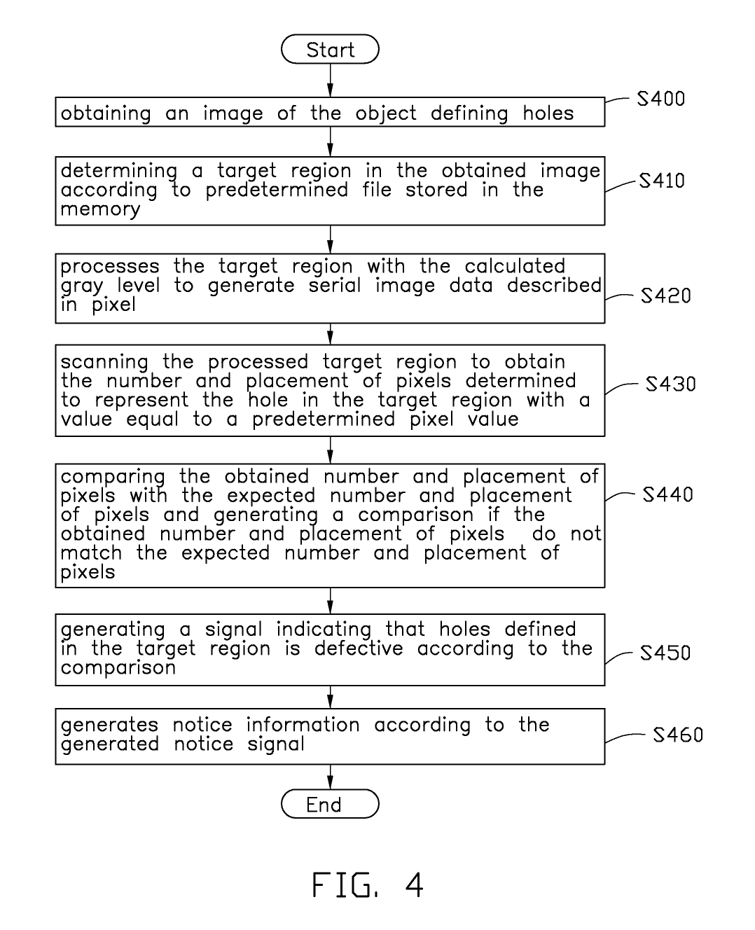

Referring to FIG. 4, a method for checking holes position and size in a steel plate is shown. The method includes the following steps, each of which is tied to various modules contained in the checking apparatus 20 as shown in FIGS. 1 and 3.

At step S400, the image obtaining unit 21 obtains an image of the steel plate.

At step S410, the position determining module 401 determines a target region in the obtained image according to the position of holes recorded in the predetermined file.

At step S420, the image processing module 402 processes the target region to generate image data, in the embodiment, the image processing module 402 processes the target region with the calculated gray level to generate serial image data described in pixel.

At step S430, the scanning module 403 scans the target region processed by the image processing module 402 with gray level to obtain the number and placement of pixels determined to represent the hole in the target region with a value equal to a predetermined pixel value.

At step S440, the comparing module 404 compares the obtained number and placement of pixels determined to represent the hole with the expected number and placement of pixels and generates a comparison if the obtained number and placement of pixels do not match the expected number and placement of pixels.

At step S450, the controlling module 405 generates a signal indicating that holes defined in the target region is defective according to the comparison.

At step S460, the outputting unit 23 generates information according to the signal generated by the controlling module 405.

As described above, by virtue of the checking apparatus 20 for checking holes position and size in a plate and the method applied, thereby, the defective holes defined in the steel plate can be checked.

It is believed that the present embodiments and their advantages will be understood from the foregoing description, and it will be apparent that various changes may be made thereto without departing from the spirit and scope of the disclosure or sacrificing all of its material advantages, the examples described merely being preferred or exemplary embodiments of the disclosure.

What is claimed is:

1. A checking apparatus, for checking holes position and size in a plate, the checking apparatus comprising:
a memory for storing a predetermined file, wherein the predetermined file records an expected number, size and placement of pixels determined to represent the holes and a predetermined pixel value;
an image obtaining unit for obtaining an image of the plate, and
a processor for determining a target region in the obtained image according to predetermined file recorded in the predetermined file, scanning the target region to obtain the number and placement of pixels determined to represent the hole in the target region with a value equal to a predetermined pixel value, and further comparing the obtained number and placement of pixels determined to represent the hole with the expected number and placement of pixels, and generating a signal to indicate the holes defined in the target region is defective if the obtained number and placement of pixels do not match the expected number and placement of pixels.

2. The checking apparatus of claim 1, wherein the predetermined file further records positions where the holes should be defined in the steel plate.

3. The checking apparatus of claim 2, wherein the positions where the holes should be defined are indicated using an X, Y-coordinate system.

4. The checking apparatus of claim 1, wherein the processor comprised a determining module, a scanning module, a comparing module and a controlling module, the determining module is configured for determining a target region according to the predetermined file, the scanning module is configured for scanning the target region to obtain the number and placement of pixels determined to represent the hole in the target region with a value equal to a predetermined pixel value, the comparing module is configured to compare the obtained number and placement of pixels determined to represent the hole with the expected number, size and placement of pixels and generate a signal indicating the hole in the target region is defective if the comparison is not a match, the controlling module generates a notice signal according to the signal generated by the comparing module.

5. The checking apparatus of claim 4, wherein the processor further comprises an image processing module, wherein the image processing module is configured to process the target region to generate image data.

6. The checking apparatus of claim 5, wherein the image processing module converts the target region to the grayscale digital image.

7. The checking apparatus of claim 1, further comprising an outputting unit, the outputting unit for outputting a notice information according to the signal generated by the processor.

8. A method for checking holes position and size in a plate, the method comprising:
obtaining an image of the plate defining holes;
determining a target region in the obtained image according to a predetermined file;
scanning the target region to obtain the number and placement of pixels determined to represent the hole in the target region with a value equal to a predetermined pixel value;
comparing the obtained number and placement of pixels determined to represent the hole with the expected number and placement of pixels and generating a comparison; and
generate a signal indicating the hole in the target region is defective if the comparison is not a match.

9. The method of claim 8, further comprises:
processing the target region to generate image data; and
scanning the processed target region to obtain the number and placement of pixels determined to represent the hole in the target region with a value equal to a predetermined pixel value.

10. The method of claim 9, wherein the target region is converted to the grayscale digital image.

11. The method of claim 8, further comprising:
outputting a notice information according to the notice signal.
